(19) United States
(12) Patent Application Publication
(10) Pub. No.: US 2010/0145241 A1
(43) Pub. Date: Jun. 10, 2010

(54) Medical Apparatus For Treatment Of The Human Or Animal Body By Mechanical Pressure Waves Or Shock Waves

(76) Inventors: Gerold Heine, Ohningen (DE); Klaus-Martin Irion, Emmingen-Liptingen (DE); Ernst H. Marlinghaus, Bottighofen (CH); Maufred Schulz, Taegerwilen (CH); Pavel Novak, Stetten (CH)

Correspondence Address: ST. ONGE STEWARD JOHNSTON & REENS, LLC, 986 BEDFORD STREET, STAMFORD, CT, 06905-5619, US

(21) Appl. No.: 12/627,808

(22) Filed: Nov. 30, 2009

Related U.S. Application Data
(63) Continuation of application No. PCT/EP2008/004010, filed on May 20, 2008.

(30) Foreign Application Priority Data
May 31, 2007 (DE) 20 2007 007 922.2

(51) Int. Cl. A61H 23/00

(52) U.S. Cl. 601/107

(57) ABSTRACT

A medical apparatus for treatment of the human or animal body by mechanical pressure waves or shock waves, comprising a device designed to generate the pressure waves or shock waves and having at least one applicator part that comprises an input face, to which an impact can be repeatedly applied in order to generate the pressure waves or shock waves, and that comprises an output face, from which the pressure waves or shock waves are applied into the body, said applicator part being made at least partially of plastic or ceramic. At least one weight element that increases the weight of the applicator part is arranged on the applicator part between the input and output faces, said input face and output face being made of plastic or ceramic.

### CROSS-REFERENCE TO RELATED APPLICATIONS

The present application is a continuation of pending international patent application PCT/EP2008/004010 filed on May 20, 2008 which designated the United States, and which claims priority of German utility model application No. 20 2007 007 922.2 filed on May 31, 2007.

### BACKGROUND OF THE INVENTION

The invention generally relates to medical apparatus for treatment of the human or animal body by mechanical pressure waves or shock waves. More specifically, the invention relates to medical apparatus of the type comprising a device designed to generate the pressure waves or shock waves and having at least one applicator part that comprises an input face, to which an impact can be repeatedly applied in order to generate the pressure waves or shock waves, and that comprises an output face, from which the pressure waves or shock waves are applied into the body, wherein the applicator part being made at least partially of plastic or ceramic.

Within the meaning of the present invention, “treatment of the human or animal body” signifies, for example, treatment of soft tissue, in particular for alleviating pain, treatment of bone tissue, treatment for cell activation, but also crashing of stones in the body, removal of plaque from vessels, treatment of teeth, removal of bone cement or driving-in of bone nails or wires.

An apparatus known from the abovementioned document DE 20 2004 007 663 U1 is used in particular for the healing process, for example after bone fractures or in cases of tendinopathy, and also for treatment of pain in the soft-tissue area.

In the known apparatus and also in the apparatus according to the present invention, the therapeutic pressure waves or shock waves are generated outside the body.

The known medical apparatus comprises a device designed to generate the pressure waves or shock waves and having an applicator part that comprises an input face and an output face. According to a first illustrative embodiment of the known apparatus, the applicator part is made of plastic in the area of its output face. In the proximal area, the applicator part has a metal rod, which forms the actual input face of the applicator part. In order to generate the pressure waves or shock waves in the applicator part at its input face, the metal rod is repeatedly impacted by a pneumatically driven percussion part, as a result of which a pressure wave or shock wave is generated in the metal rod and is transmitted to the plastic distal output face of the applicator part and applied into the body. The pressure waves or shock waves are also generated by the translatory movement of the applicator part, said translatory movement being caused by the impacts on the input face.

According to another illustrative embodiment of the known apparatus, the applicator part is again made of plastic in the distal area of the output face, and at its proximal end it has a metal ball that forms the input face of the applicator part.

The disadvantage of this known apparatus is that there is an impedance jump between the proximal metal rod or metal ball and the plastic area of the applicator, as a result of which some of the pressure waves or shock waves are reflected back and, consequently, do not reach the output face.

Document DE 197 25 477 C2 discloses a medical apparatus for treatment of the human or animal body by mechanical pressure waves or shock waves, in which the device for generating the pressure waves or shock waves comprises an applicator part made entirely of metal.

The use of an applicator part made of metal, particularly in the area of the output face via which the pressure waves or shock waves are applied into the body, has the disadvantage that there is a great difference in impedance between the output face of the applicator part and the surface of the body onto which the output face is placed. The result of this is that the pressure waves emerging from the output face are reflected back from the surface of the body. By contrast, an applicator part made of plastic or ceramic, at least in the area of the output face, has an impedance better adapted to the impedance of the surface of the body, such that the pressure waves emerging from the output face are reflected back to a lesser extent from the surface of the body and are therefore better applied into the surface of the body. More mechanical energy is thus advantageously applied into the tissue that is to be treated.

Although an applicator part made partially of plastic is used in the apparatus known from document DE 20 2004 007 663 U1, the pressure waves or shock waves are still generated via the metal proximal end of the applicator part, which changes the acoustic properties of the whole applicator part to such an extent that they do not correspond to those of a part made purely of plastic.

On the other hand, the use of an applicator part made exclusively of plastic or ceramic has the disadvantage of sometimes being very light in weight, which leads to very high accelerations of the applicator part when subjected to the impacts. This can cause an unpleasant sensation on the patient's skin.

### SUMMARY OF THE INVENTION

The object of the invention is therefore to improve a medical apparatus of the type mentioned at the outset in such a way that the aforementioned disadvantages are avoided and, in particular, such that the pressure waves or shock waves are generated efficiently and are applied efficiently into the body.

According to an aspect of the invention, a medical apparatus for treatment of the human or animal body by mechanical pressure waves or shock waves is provided, comprising a device designed to generate the pressure waves or shock waves, the device for generating the pressure waves or shock waves having at least one applicator part, the applicator part having an input face to which an impact can be repeatedly applied in order to generate the pressure waves or shock waves, and an output face, from which the pressure waves or shock waves are applied into the body, the applicator part being made at least partially of plastic or ceramic, at least one weight element which increases the weight of the applicator part, the weight element being arranged on the applicator part between the input and output faces, the input face and output face being made of plastic or ceramic.

In the apparatus according to the invention, the applicator part is made of plastic or ceramic, at least in the area of its input face and output face, and it can in particular be made entirely of plastic or ceramic. In order to avoid excessive acceleration of the applicator part rendered light in weight when made of plastic or ceramic, which acceleration, as has been described above, can cause an unpleasant sensation on the patient's skin, a weight element that increases the weight of the applicator part is arranged on the applicator part between the input face and the output face. Thus, in the apparatus according to the invention, the more favorable acoustic properties of plastic or ceramic, compared to a metal applicator, are exploited to generate the pressure waves or shock waves and to apply these waves into the body, while the disadvantages of excessive acceleration of the applicator part because of its low weight are avoided by the weight element. On the other hand, however, the weight element does not change the acoustic properties of the applicator part but instead only increases the weight of the latter.

In a preferred embodiment, the weight element is arranged on a lateral outer circumferential face of the applicator part.

This measure has, on the one hand, the advantage that the weight element does not influence or change, or does not appreciably influence or change, the acoustic properties of the applicator part, and, on the other hand, the advantage that the weight element can be connected to the applicator part in a particularly simple way, for example by being bonded on.

In another preferred embodiment, the weight element is designed as a sleeve that surrounds the outer circumference of the applicator part.

The design of the weight element as a sleeve that surrounds the outer circumference of the applicator part has the advantage, on the one hand, of improved weight symmetry in relation to the longitudinal center axis of the applicator part, and, on the other hand, during connection to the applicator part, the sleeve can be easily pushed onto the applicator part and secured thereon.

In another preferred embodiment, the weight element is made at least partially of metal.

Making the weight element at least partially of metal, preferably entirely of metal, has the advantage that metals or metal alloys, for example brass, have a high specific weight, as a result of which the weight element can be made small in size while still having a considerable weight. This is particularly of advantage if, as in one of the abovementioned embodiments, the at least one weight element is arranged on the lateral outer face of the applicator part, as a result of which the transverse dimension of the applicator part including the weight element is not greatly increased.

In another preferred embodiment, the applicator part is made entirely of plastic or ceramic.

If the applicator part is made entirely of plastic, the positive acoustic properties of plastic can be exploited to best effect in generating the pressure waves or shock waves and introducing them into the body, in which respect the at least one weight element provided according to the invention avoids the disadvantages of an applicator part made exclusively of plastic or ceramic, namely excess acceleration of the applicator part when subjected to the impacts.

In another preferred embodiment, the applicator part is made at least partially of PMMA or PEEK (polymethyl methacrylate or polyether ether ketone).

PMMA (Plexiglas) is particularly suitable in terms of the acoustic impedance, which is close to the acoustic impedance of body tissue. PEEK is particularly advantageous in terms of its high degree of resistance to wear, in particular its impact strength.

The applicator part can also be made of a combination of the two aforementioned plastics or also in combination with ceramic.

Further advantages and features will become evident from the following description and from the attached drawing.

It will be appreciated that the aforementioned features to be explained in more detail below can be used not only in the respectively cited combination, but also in other combinations or singly, without departing from the scope of the present invention.

### BRIEF DESCRIPTION OF THE DRAWINGS

An illustrative embodiment of the invention is depicted in the drawing and is described in more detail below with reference to said drawing, in which:

FIG. 1 shows a schematic longitudinal section through a medical apparatus for treatment of the human or animal body by mechanical pressure waves or shock waves; and

FIG. 2 shows an enlarged detail of the distal end of the apparatus in FIG. 1.

### DETAILED DESCRIPTION OF A PREFERRED EXEMPLARY EMBODIMENT

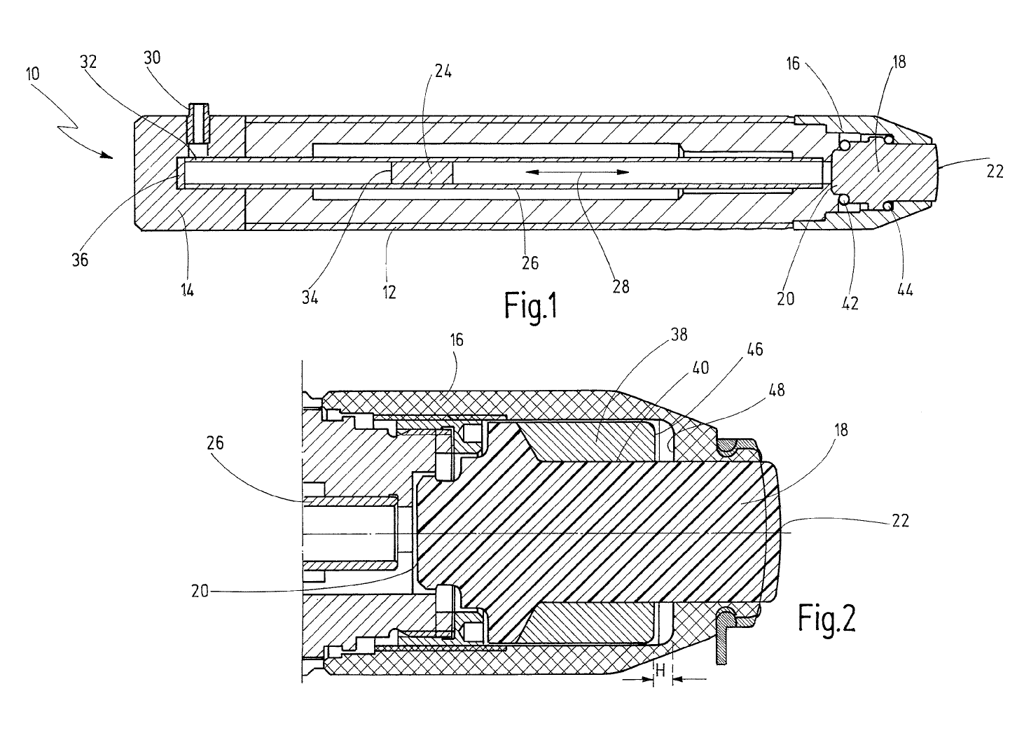

In FIG. 1, a medical apparatus for treatment of the human or animal body by mechanical pressure waves or shock waves is designated overall by reference number 10. The apparatus 10 is used, for example, for the treatment of pain or generally for the treatment of soft tissue.

The apparatus 10 generally has a housing 12 with a proximal endpiece 14 and a distal headpiece 16. The apparatus 10 is in the form of a rod-shaped handpiece.

The apparatus 10 has a device which is designed to generate pressure waves or shock waves and which has an applicator part 18 arranged in the distal headpiece 16 at the distal end of the housing 12.

The applicator part 18 has a proximal input face 20 and a distal output face 22. Pressure waves or shock waves are generated in the applicator part 18 by way of the input face 20, and they are also generated by the translatory movement of the applicator part. For this purpose, at least one percussion part 24 is arranged in the housing 12 and can be moved to and fro, according to a double arrow 28, in a guide tube 26 extending in the longitudinal direction of the housing 12, in order to repeatcdly impact the input face 20 of the applicator part 18. The percussion part 24 is moved in the distal direction by means of compressed air, for which reason a compressed air inlet 30 is arranged on the proximal endpiece 14 of the housing 12, through which compressed air from an external source (not shown) of compressed air is introduced in pulses into the guide tube 26 via an opening 32, and the introduced compressed air acts on a proximal face 34 of the percussion part 24 and, in this way, the percussion part 24 is accelerated from a starting position at 36 toward the applicator part 18.

Each time the percussion part 24 impacts the input face 20 of the applicator part 18, a pressure wave or shock wave is induced in the latter and propagates through the applicator part 18 to the output face 22 and emerges from the latter to be applied into the body of a patient.

The percussion part 24 can be made of metal, plastic or other materials.

In order to generate the pressure waves or shock waves in the applicator part 18, other mechanisms for generating pressure waves or shock waves can be considered instead of the percussion part 24, for example by using an electrohydraulic transducer, an electromagnetic transducer or the like.

FIG. 2 is an enlarged view of the distal end of the apparatus 10.

As is shown in FIG. 2, the applicator part 18 is made entirely of plastic, preferably of PMMA or PEEK, or it can also be made in several parts from a combination of these two plastics or of other plastics.

The applicator part 18 can also be made entirely of ceramic, or of a combination of plastic and ceramic, in which case, for example, the input face and output face can be made of plastic and the area between them can be made of ceramic.

Moreover, a weight element 38 is arranged on the applicator part 18, on a lateral outer circumferential face 40 of the applicator part 18, and is connected securely thereto. However, the weight element 38 can also be connected to the applicator part 18 in such a way as to be removable from said applicator part 18.

The weight element 38 is made entirely of metal, for example of brass, and the arrangement of applicator part 18 and weight element 38 has a total weight that is approximately 10% to 100% of or greater than the weight of the applicator part 18 alone.

However, pressure waves or shock waves that propagate from the input face 20 to the output face 22 of the applicator part 18 are not changed or influenced, or are not appreciably changed or influenced, by the weight element 38.

The weight element 38 is designed in particular in the form of a sleeve that surrounds the outer circumference of the applicator part 18.

As is shown in FIG. 2, the applicator part 18 is mounted with a short stroke H in the distal headpiece 16, and, according to FIG. 1, a proximal damping element 42 and a distal damping element 44, for example in the form of O-rings made of an elastomeric material, are present in order to damp the linear movement of the applicator part 18. The damping element 44 is arranged between a distal end face 46 of the applicator part 18 or weight element 38 and a housing surface 48. The damping elements 42 and 44 are not shown in FIG. 2. Depending on the choice of damping elements, a greater or lesser stroke of the applicator part 18 can be set, in particular also one that is greater than the stroke illustrated in FIG. 2.

What is claimed is:

1. A medical apparatus for treatment of the human or animal body by mechanical pressure waves or shock waves, comprising
a device designed to generate said pressure waves or shock waves,
said device for generating said pressure waves or shock waves having at least one applicator part,
said applicator part having an input face to which an impact can be repeatedly applied in order to generate said pressure waves or shock waves, and an output face, from which said pressure waves or shock waves are applied into said body,
said applicator part being made at least partially of plastic or ceramic,
at least one weight element which increases the weight of said applicator part, said weight element being arranged on said applicator part between said input and output faces, said input face and output face being made of plastic or ceramic.

2. The apparatus of claim 1, wherein said weight element is arranged on a lateral outer circumferential face of said applicator part.

3. The apparatus of claim 2, wherein said weight element is designed as a sleeve that surrounds said outer circumferential face of said applicator part.

4. The apparatus of claim 1, wherein said weight element is made at least partially of metal.

5. The apparatus of claim 1, wherein said applicator part is made entirely of plastic.

6. The apparatus of claim 1, wherein said applicator part is made entirely of ceramic.

7. The apparatus of claim 1, wherein said applicator part is made at least partially of PMMA or PEEK.
